(19) United States
(12) Patent Application Publication
(10) Pub. No.: US 2011/0259939 A1
(43) Pub. Date: Oct. 27, 2011

(54) TRANSDUCER OF AN ULTRASONIC BONDER

(75) Inventor: Farhad Farassat, Taufkirchen (DE)

(73) Assignee: F & K Delvotec Bondtechnik GmbH, Ottoburn (DE)

(21) Appl. No.: 12/765,661

(22) Filed: Apr. 22, 2010

(51) Int. Cl. B23K 20/10

(52) U.S. Cl. 228/1.1

(57) ABSTRACT

A bonding tool is attached to a transducer of an ultrasonic bonder with several screws, at least two of which are advantageously disposed at different heights when the transducer is in its operating position. The transducer may comprise a bore in which the bonding tool is disposed. The bore may have a circumference that is expanded away from the transducer's free end.

### BACKGROUND OF THE INVENTION

1. Field of the Invention

The invention relates to a transducer of an ultrasonic bonder, in particular a wire bonder, as well as to a bonding head provided therewith and to a wire bonder equipped with such a bonding head.

2. Description of the Related Art

Ultrasonic bonders have long been known and commercially available in various embodiments, some of them provided by the applicant. They consist of a bonding head in which at least one ultrasonic converter element—typically a group of converter elements—is disposed, and which generates ultrasonic oscillations that are transmitted by way of a transducer to a bonding tool, in particular to a bonding “wedge”. The bonding tool then transmits the ultrasonic energy to an object positioned at the site, in particular a bonding wire placed above a switching-circuit substrate, where a bonded connection is thereby produced. In commercially available wire bonders the wedge is enclosed within a bore in the transducer, where it is releasably fixed by means of a screw.

In order to produce a high-quality bonded connection, which in particular has a prespecified tensile strength, it is of crucial significance that the oscillation characteristic of the bonding tool is precisely predetermined and can also be maintained in the long term.

In this regard, known bonding heads have been found to exhibit irregularities that can lead to deficient quality of the bonded connections they produce, and in the extreme case can cause premature failure of these connections.

### SUMMARY OF THE INVENTION

The objective of the present invention is thus to provide a transducer with improved function, in particular during long-term employment under production conditions.

This objective is achieved in one embodiment by a transducer of an ultrasonic bonder, which comprises several screws for attachment of the bonding tool, at least two of which are disposed at different heights when the transducer is in, its operating position.

The invention originated from the idea that the known, simple and functionally quite secure attachment of the bonding tool to the transducer should be tested with regard to its oscillation characteristics, specifically the oscillation characteristic of the converter elements (piezo elements) that are typically employed here. When this test was performed, the inventor discovered the problem that the substantially punctate fixation of the relatively elongated bonding tool within the transducer results in localized friction peaks and corresponding peaks in temperature, as well as reduced performance. This evidently causes a locally elevated abrasion and consequently an impaired transmission of oscillation to the bonding tool.

On the basis of this discovery, the invention includes the concept of replacing the substantially punctate fixation of the bonding tool by a more linear or two-dimensional fixation. The invention further includes the concept that only limited structural changes should be needed for this physical-geometric transformation. Given these considerations, fixation with several screws proves to be a good compromise, and in practice it has delivered convincing results. In particular, it enables the bond to be endowed with higher performance and functions reliably for long periods of operation.

In one embodiment of the invention at least two of the screws are disposed one above the other. As well as these two vertically disposed screws, further fixation points can be provided, e.g. additional screws or another element inserted between the two aforementioned screws.

In an especially simple and nevertheless reliably operating embodiment, precisely two screws disposed vertically, one above the other, are provided to attach the bonding tool.

In one embodiment that is especially significant for practical purposes it is provided that the transducer is constructed as a rod, in particular with a substantially circular cross section, and two of the screws extend in a vertical plane of symmetry of the rod. Specifically, this embodiment can be designed so that the transducer comprises near its free end an opening oriented vertically when the bonding head is in its operating position, into which the bonding tool is inserted, and the screws extend at a right angle to the longitudinal extent of the opening and hence the bonding tool. In principle, however, the wedge can also be mounted on the free end face of the transducer, in particular by means of an anchoring clamp or the like.

In the embodiment comprising a bonding tool retained within a bore, it is advantageous for the bore to be expanded in its circumferential region away from the free end. Good results in practice have been achieved particularly with a configuration such that the cross section of the expanded region is substantially triangular.

### BRIEF DESCRIPTION OF THE DRAWINGS

In the following the invention is explained in greater detail with reference to the figures, which show:

FIG. 1 a diagram of the basic structure of a wire bonder to produce a bonded connection of a wire, and

FIGS. 2A to 2C views of an embodiment of the bonding head in accordance with the invention.

### DETAILED DESCRIPTION

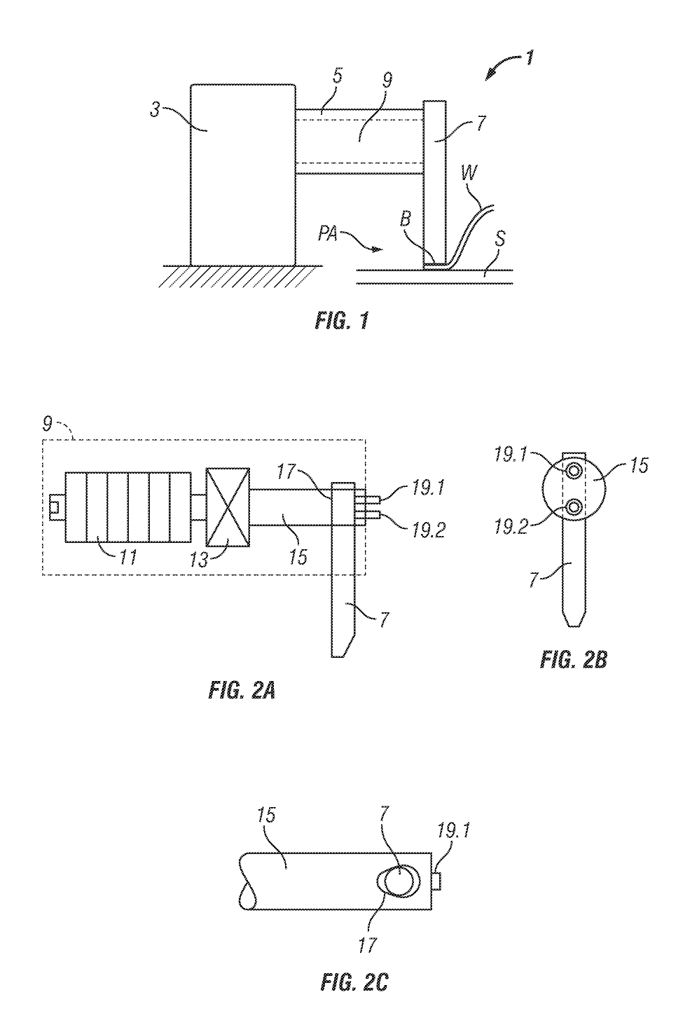

As shown in FIG. 1, a wire bonder 1 has a machine body 3 to which is attached a bonding head 5 which extends over an operating section PA, within which a bonded connection (“bond”) B to a substrate S is produced by way of a bonding wire W. For this purpose a wedge 7 fixed to the bonding head 5 acts on the bonding wire W. The bonding head 5 comprises an ultrasonic converter arrangement 9, which is electrically driven and mechanically connected to the bonding tool 7.

FIGS. 2A to 2C show the ultrasonic converter arrangement 9 and the bonding tool 7 in an embodiment in accordance with the invention. The converter arrangement 9 comprises a plurality of piezo elements 11 and a transducer 15 mounted within a transducer holder 13. As can best be seen in FIGS. 2A and 2C, within the transducer 15, near one of its free ends, a bore 17 oriented perpendicular to the transducer's longitudinal extent is provided, within which the bonding tool 7 is disposed with its long axis vertically oriented when in operating position. In the embodiment shown here the transducer 15 is constructed as a cylindrical rod, and the bore 17 and hence also the bonding tool 7 are disposed centrally therein.

Within the common plane of symmetry two fixation screws 19.1 and 19.2 extend in the long direction of the transducer 15, from its free end to the surface of the bonding tool (bonding wedge) 7 that faces this end. These screws 19.1 and 19.2 are screwed in sufficiently to press the bonding tool 7 against the surface of the bore 17 away from the free end of the transducer, as a result of which the bonding tool is fixed within the bore and hence in the transducer. The use of two screws positioned one above the other creates a linear, vertically oriented pressure contact between tool and transducer, which is advantageous from the viewpoint of oscillation technology.

As can be seen in FIG. 2C, in the embodiment shown here the otherwise circular cross section of the bore 17 is expanded in the region away from the free end of the transducer 15, so as to acquire a substantially triangular shape. As a result, the contact region between bonding tool and wall of the bore is different from that which would exist in a circular bore; it has changed from one linear contact to a pair of linear contacts, i.e. stripe-shaped contact regions. This configuration further improves the oscillatory behavior, reduces local friction peaks and thereby also local warming, and thus increases the durability of the device when employed in production.

The embodiment of the invention is not limited to this example, but is also possible in numerous modifications that are within the scope of a person skilled in the art. For instance, the fixation screws need not necessarily be disposed vertically above one another, or the vertically positioned screws can be supplemented by additional screws or other means of fixing or pressing against the bonding tool. The expansion of the bore in the transducer preferentially provided here need not necessarily be triangular in cross section, but can also be formed by another bore separate from the bearing-bore of the bonding tool and disposed parallel thereto or, e.g., can be rectangular or elliptical in shape.

1. A transducer of an ultrasonic bonder, which comprises a plurality of screws for attachment of a bonding tool, at least two of which are simultaneously installed, which attach the bonding tool to the transducer,. and which are disposed at different heights when the transducer is in its operating position, wherein the transducer near its free end comprises an opening that extends vertically when the transducer is in its operating position and within which the bonding tool is contained.

2. The transducer according to claim 1, wherein at least two of the screws are disposed vertically one above the other.

3. The transducer according to claim 2, wherein precisely two screws disposed vertically one above the other are provided to fix the bonding tool in position.

4. The transducer according to claim 1, constructed as a rod, in particular with substantially circular cross section, such that two of the screws extend within a vertical plane of symmetry of the rod.

5. The transducer according to claim 4, wherein the screws extend at right angles to the long dimension of the opening and hence to that of the bonding tool.

6. The transducer according to claim 5, wherein the opening is constructed as a bore, the circumference of which is expanded in a section away from the transducer's free end.

7. The transducer according to claim 6, wherein the expansion has a substantially triangular shape in cross section.

8. A bonding head of an ultrasonic bonder, with an ultrasonic converter arrangement which comprises at least one ultrasonic converter element and a transducer according to claim 1.

9. The bonding head according to claim 8, wherein the bonding tool is constructed as a bonding wedge.

10. A wire bonder with a bonding head according to claim 8.

11. A transducer of an ultrasonic wire bonder, which comprises a plurality of screws for attachment of a bonding wedge, at least two of which are parallel to each other and are disposed at different heights when the transducer is in its operating position, wherein the transducer near its free end comprises an opening that extends vertically when the transducer is in its operating position and within which the bonding wedge is contained, such that the screws extend at right angles to the long dimension of the opening and hence to that of the bonding wedge.

12. The transducer according to claim 11, wherein at least two of the screws are disposed vertically one above the other.

13. The transducer according to claim 12, wherein precisely two screws disposed vertically one above the other are provided to fix the bonding wedge in position.

14. The transducer according to claim 11, constructed as a rod, in particular with substantially circular cross section, such that two of the screws extend within a vertical plane of symmetry of the rod.

15. The transducer according to claim 14, wherein the opening is constructed as a bore, the circumference of which is expanded in a section away from the transducer's free end.

16. The transducer according to claim 15, wherein the expansion has a substantially triangular shape in cross section.

17. A bonding head of an ultrasonic wire bonder with an ultrasonic converter arrangement which comprises at least one ultrasonic converter element and a transducer according to claim 11.

18. A wire bonder with a bonding head according to claim 17.
